(19) United States
(12) Patent Application Publication
(10) Pub. No.: US 2006/0116126 A1
(43) Pub. Date: Jun. 1, 2006

(54) Radio communication terminal and handoff control method

(75) Inventor: Hiroyuki Hidaka, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/260,525

(22) Filed: Oct. 27, 2005

(30) Foreign Application Priority Data
Oct. 28, 2004 (JP) P.2004-314588

(51) Int. Cl. H04Q 7/20

(52) U.S. Cl. 455/436

(57) ABSTRACT

A radio communication terminal has a communication section which communicates with a base station, and a control section which controls a handoff between a plurality of base stations. The communication section receives a control information indicating whether or not a neighboring base station broadcasts a service information from the neighboring base station when the radio communication terminal performs a handoff from a first base station to the neighboring base station while the radio communication terminal receives the service information broadcasted from the first base station. The control section controls to perform a handoff from the neighboring base station to the first base station when the control section decides that the neighboring base station does not broadcast the service information based on the control information, after the radio communication terminal performs the handoff from the first base station to the neighboring base station.

### CROSS-REFERENCE TO RELATED APPLICATIONS

This application is based upon and claims the benefit of priority from the prior Japanese Patent Applications No. 2004-314588, filed on Oct. 28, 2004, the entire contents of which are incorporated herein by reference.

### BACKGROUND OF THE INVENTION

1. Field of the Invention

The present invention relates to a radio communication terminal used in a radio communication system that can deal with a broadcast service and/or a multicast service, and a handoff control method of the radio communication terminal.

2. Description of the Related Art

In the radio communication system, as the technology to continue a communication while moving among service areas (e.g., cells or sectors) of the base stations, the process of switching the base station, to which the radio communication terminal is to be connected, in response to the signal quality of a communication between the radio communication terminal and the base station (referred to as the “handoff” hereinafter) is carried out. Such radio communication terminal executes the process of holding a more appropriate radio condition, while measuring both signal strength of the signal transmitted from the base station to which this terminal is communicated and signal strength of the signals transmitted from other neighboring base stations.

For instance, in the case of the CDMA radio communication system of IS-95 system, a radio communication terminal measures the signal strength (signal quality) transmitted from the base station to which this terminal is communicated currently and the signal strength of the signals transmitted from other neighboring base stations. Then, when the radio communication terminal is in communication with the base station, such radio communication terminal transmits the measured signal strength to the base station, and then the base station makes a decision of handoff based on this signal strength. In contrast, when the radio communication terminal is in an idle state, such radio communication terminal makes by itself a decision of handoff based on the measured signal strength. The radio communication terminal in such CDMA radio communication system is set forth in JP-A-2002-171555, for example.

JP-A-2002-171555 is referred to as a related art.

Meanwhile, in the above handoff method as the related art, the radio communication terminal controls to perform a handoff based on the signal strength of the signals transmitted from the base stations around this radio communication terminal. Therefore, in the case the user receives the information service that is offered only in particular base station groups (areas), when such user continuously receives the information service to extend over the areas, it must be taken into account in performing the handoff whether or not the information service can be offered in the areas.

As such information service, there are the broadcast service or the multicast service, for example. The broadcast service is defined as such a new service mode that the base station transmits the data continuously in a connectionless manner, i.e., “broadcasts” the data, to the overall radio communication terminals existing in its own service areas (e.g., cells or sectors) by utilizing the radio communication network.

Also, the multicast service provides a service similar to the broadcast service. But this multicast service is defined as such a service mode that the base station broadcasts the data such that only limited users who hold a contract of particular service information (e.g., pay service) among the radio communication terminals in the service areas (e.g., cells or sectors) can watch and listen the contents.

As the data type that is broadcasted via the broadcast service or the multicast service, in particular there are the character information, the speech/music information, the streaming video information, and the like. In this specification, these information are called “service information”. Also, in this specification, the broadcast service/multicast service is abbreviated as “BCMCS”.

An example of such BCMCS will be explained hereunder. The base station that handles the broadcast of service information transmits a control signal indicating whether or not the BCMCS service information is now on the air, on a control channel, while the radio communication terminal receives this control signal. The radio communication terminal checks whether or not the service information that is now on the air is present. Then, when the available service information is broadcasted, the user transmits a broadcast request signal to the base station by starting a predetermined communication program to utilize the service information or choosing a predetermined mode to receive the service information. The base station, when receives this broadcast request signal, secures a part of another channels (e.g., communication channels) as the BCMCS channel and then starts the broadcast of the service information over this BCMCS channel. Then, the radio communication terminal transmits periodically the broadcast request signal, while the base station side ends the transmission of the service information and then releases the BCMCS channel when the radio communication terminal that transmits this broadcast request signal went away from the service area.

In this manner, the BCMCS utilizes a part of the channels as the precious radio resource as the BCMCS channel in response to the broadcast request signal that the radio communication terminal transmits, to deliver the broadcast of the service information. In this event, because the radio communication terminal that is receiving the BCMCS performs the handoff, it is possible that this precious radio resource is wasted. In other words, when the base station as the destination of handoff is not broadcasting the service information, the radio communication terminal transmits the broadcast request signal to receive continuously the service information whereas the base station starts the broadcast of the service information by sharing a part of the channels with the BCMCS channel. As a result, the base station must be able to use the channel as the precious radio resource because there is no other radio communication terminal, which wishes to receive the service information, except this radio communication terminal in the service area of such base station as the destination of handoff, nevertheless the base station must start the broadcast of the service information at the sacrifice of this channel only because just one radio communication terminal enters into the service area, which yields the inefficient profitable employment of the precious radio resource.

For example, in an example shown in FIG. 7, the cells each composed of the base station are provided to locate contiguously or overlap partially. At this time, as shown in FIG. 7, in case the same service information is broadcasted from all the base station, the radio communication terminal can receive continuously a provision of the service information that such terminal is now receiving even when the radio communication terminal 1 that is receiving the service information performs a handoff to any base station. However, as shown in FIG. 8, in case the service information is broadcasted from a part of base stations (A to D) but the service information is not broadcasted from remaining base stations (E to G), sometimes the radio communication terminal 1 that is receiving the service information from the base station A enters into the service area of the base station G that is located adjacent to the base stations A and B, as shown in FIG. 8, at a time when such radio communication terminal 1 is moved into the service area of the base station B. In this case, the radio communication terminal 1 performs a handoff to the base station G that is not broadcasting the service information, and then the base station G starts the broadcast of the service information by allocating a part of the traffic channels to the BCMCS channel because only one radio communication terminal 1 enters into the service area for a moment, whereby the radio resource is used wastefully.

The base station sends the BCMCS control information indicating whether or not the service information is broadcasted within its own service area, and the radio communication terminal cannot know whether or not the base station broadcasts the service information until this terminal receives this control information. Therefore, unless the radio communication terminal once performs a handoff to the neighboring base stations even when such radio communication terminal is receiving the service information, such radio communication terminal cannot know whether or not the neighboring base stations broadcast the service information. As a result, when the neighboring base station as the destination of handoff does not broadcast the service information, consequently the broadcast request signal of the service information is sent from the radio communication terminal.

In summary, when the radio communication terminal of the related art performs a handoff to the base station that does not broadcast the service information while the radio communication terminal receives the BCMCS service information, the base station must broadcast the BCMCS service information to just one radio communication terminal with using a channel. As a result, the radio resource is ineffectively wasted.

### SUMMARY OF THE INVENTION

An object of the invention is to provide a radio communication terminal which prevents wasteful use of the radio resource when the radio communication terminal performs a handoff to the other base station while the radio communication terminal receives the BCMCS service information.

The invention provides a radio communication terminal, having: a communication section which communicates with a base station; and a control section which controls a handoff between a plurality of base stations, wherein the communication section receives a control information indicating whether or not a neighboring base station broadcasts a service information from the neighboring base station when the radio communication terminal performs a handoff from a first base station to the neighboring base station while the radio communication terminal receives the service information broadcasted from the first base station, and the control section controls to perform a handoff from the neighboring base station to the first base station when the control section decides that the neighboring base station does not broadcast the service information based on the control information, after the radio communication terminal performs the handoff from the first base station to the neighboring base station.

In the radio communication terminal, a control section derives signal quality of the service information while the radio communication terminal receives the service information broadcasted from the first base station, and the control section controls to perform the handoff from the neighboring base station to the first base station when the control section decides that the neighboring base station does not broadcast the service information based on the control information and the signal quality is greater than or equal to a predetermined value, after the radio communication terminal performs the handoff from the first base station to the neighboring base station.

In the radio communication terminal, a control section derives signal quality of the service information while the radio communication terminal receives the service information broadcasted from the first base station, and the control section controls to continue a communication with the neighboring base station and controls the communication section to send a broadcast request of the service information to the neighboring base station when the control section decides that the neighboring base station does not broadcast the service information based on the control information and the signal quality is smaller than a predetermined value, after the radio communication terminal performs the handoff from the first base station to the neighboring base station.

In the radio communication terminal, the signal quality is a bit error rate while the communication section receives the service information.

In the radio communication terminal, the control section controls to perform the handoff from the first base station to the neighboring base station when a difference between a field strength from the neighboring base station and a field strength from the first base station exceed a threshold value.

The invention also provides a handoff control method of a radio communication terminal having a communication section which communicates with a base station, and a control section which controls a handoff between a plurality of base stations, including the steps of: controlling to perform a handoff from a first base station to a neighboring base station while the radio communication terminal receives a service information broadcasted from the first base station, receiving a control information indicating whether or not the neighboring base station broadcasts a service information from the neighboring base station, after the radio communication terminal performs a handoff from the first base station to the neighboring base station, deciding whether or not the neighboring base station broadcasts the service information based on the control information, and controlling to perform a handoff from the neighboring base station to the first base station when the control section decides that the neighboring base station does not broadcast the service information.

The handoff control method further has the steps of: deriving signal quality of the service information that is received while the radio communication terminal receives the service information broadcasted from the first base station, wherein the control section controls to perform the handoff from the neighboring base station to the first base station when the control section decides that the neighboring base station does not broadcast the service information based on the control information and the signal quality is greater than or equal to a predetermined value, after the radio communication terminal performs the handoff from the first base station to the neighboring base station.

The handoff control method further has the steps of: deriving signal quality of the service information while the radio communication terminal receives the service information broadcasted from the first base station, wherein the control section controls to continue a communication with the neighboring base station and controls the communication section to send a broadcast request of the service information to the neighboring base station when the control section decides that the neighboring base station does not broadcast the service information based on the control information and the signal quality is smaller than a predetermined value, after the radio communication terminal performs the handoff from the first base station to the neighboring base station.

In the handoff control method, the signal quality is a bit error rate while the communication section receives the service information.

In the handoff control method, the control section controls to perform the handoff from the first base station to the neighboring base station when a difference between a field strength from the neighboring base station and a field strength from the first base station exceed a threshold value.

According to the radio communication terminal and the handoff control method, when the radio communication terminal performs a handoff to the other base station while the radio communication terminal receives the BCMCS service information, it can be prevented the radio resource from being used wastefully.

### BRIEF DESCRIPTION OF THE DRAWINGS

FIG. 1 is a configurative view showing a radio communication system according to an embodiment of the present invention;

FIG. 2 is a block diagram showing a radio communication terminal of the embodiment of the present invention;

FIG. 3 is a configurative view showing a channel configuration in the CDMA system of the embodiment of the present invention;

FIG. 4 is a configurative view showing a channel configuration in the TDMA system of the embodiment of the present invention;

FIG. 5 is a flowchart showing a handoff process according to a first embodiment of the present invention;

FIG. 6 is a flowchart showing a handoff process according to a second embodiment of the present invention;

FIG. 7 is a conceptual view showing a cell configuration of the radio communication system; and

FIG. 8 is a conceptual view showing a cell configuration of the radio communication system.

### DETAILED DESCRIPTION OF THE PREFERRED EMBODIMENTS

Embodiments of the present invention will be explained with reference to the drawings hereinafter.

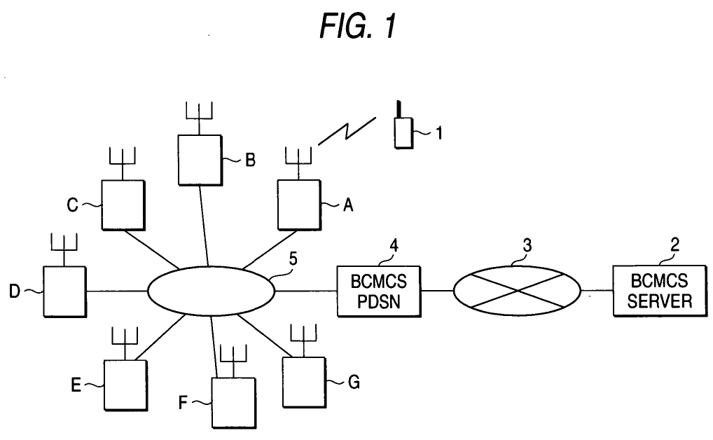

FIG. 1 is a configurative view showing a radio communication system according to an embodiment of the present invention. A broadcast service/multicast service sever (BCMCS server) 2 is connected to a broadcast service/multicast service PDSN (BCMCSPDSN) 4 via an IP network 3. The BCMCSPDSN 4 is connected to base stations A to G via a RAN 5. The BCMCS server 2 provides a server that stores the service information of the broadcast service and the multicast service, described later. PDSN and RAN signify a packet data processing node and a radio access network, respectively.

These base stations A to G have cells that their own stations cover respectively as the service areas, and transmits the service information stored in the BCMCS server 2 in a connectionless manner, i.e., broadcasts the service information, to the overall radio communication terminals existing in their service areas.

The multicast service provides a service similar to the broadcast service. The multicast service is defined as such a service mode that the base station broadcasts the information such that only limited users who hold a contract of particular service information (e.g., pay service) among the radio communication terminals existing in the service areas can watch and listen the contents.

As the data type that is broadcasted via the broadcast service or the multicast service, in particular there are the character information, the speech/music information, the streaming video information, and the like. In this specification, these information are called the “service information”. Also, in this specification, the broadcast service/multicast service is abbreviated as “BCMCS”.

In the above BCMCS, the radio communication terminal receives one-sidedly the data transmitted from the base station not to establish the connection between the radio communication terminal and the base station. Then, a forward-link channel configuration used to realize the BCMCS will be explained hereunder.

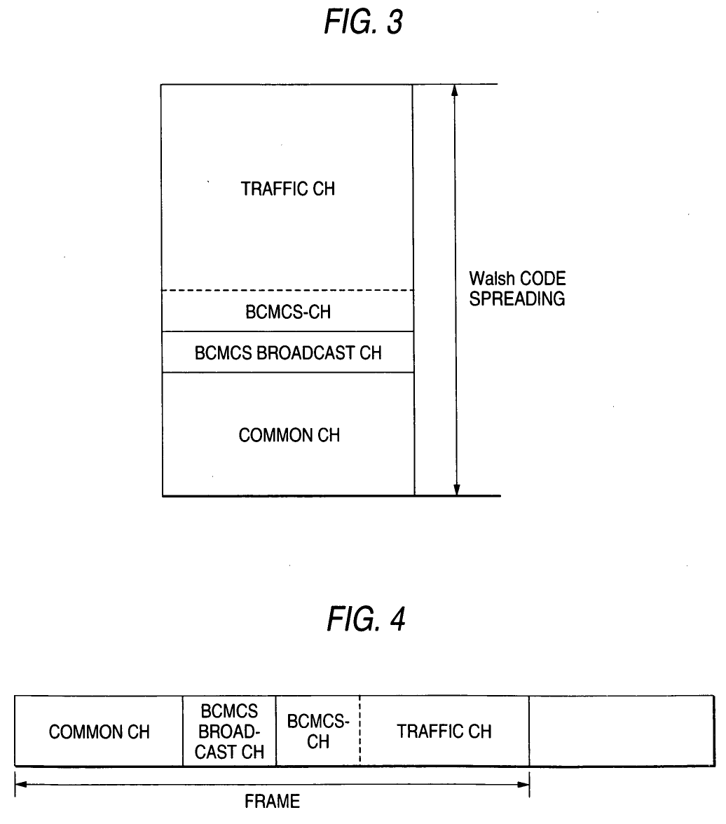

FIG. 3 shows a channel configuration in the CDMA (code division multiple access) system.

In the CDMA system, a channel division is made by spreading the usable frequency band by using a Walsh code. First, a control CH is a channel that carries the control signal to transfer control information between the base station and the radio communication terminal. Although not particularly shown, a PICH for carrying a pilot signal, a SYNC for carrying a synchronizing signal, and the like are contained in this control CH. Also, a BCMCS broadcast CH is allocated subsequently to the control CH. The BCMCS broadcast CH is a channel that carries the BCMCS control signal indicating whether or not the base station broadcasts the BCMCS at present. Also, a traffic CH is allocated subsequently to the BCMCS broadcast CH. The traffic CH is a channel that carries the data that the radio communication terminal transmitted/received to/from the other party of communication. Actually the traffic CH is spread finely to accommodate a plurality of radio communication terminals therein. In the present embodiment, a part of the traffic CH can be allocated to a BCMCS-CH that carries the BCMCS service information, and the service information is carried over this BCMCS-CH when the service information is to be broadcasted.

FIG. 4 shows a channel configuration in the TDMA (time division multiple access) system as another example.

In the TDMA system, a channel division is made by dividing the usable frequency band into predetermined times (time slots). In an example in FIG. 4, the BCMCS broadcast CH and the traffic CH are allocated subsequently to the control CH. In this case, functions of the control CH, the BCMCS broadcast CH, the traffic CH, and the BCMCS-CH are similar to those in the CDMA system.

When the radio communication terminal side starts a communication program to watch and listen the BCMCS or sets a predetermined mode to receive the BCMCS, or when the user issues the instruction to watch and listen the BCMCS, the radio communication terminal transmits the BCMCS broadcast request to the base station via a reverse link. Then, the base station, when receives this broadcast request, broadcasts the service information by carrying such information over the BCMCS-CH.

In this case, in FIG. 3 and FIG. 4, by way of example of the channel configuration, an example in which a part of the traffic CH is allocated to the BCMCS-CH is shown. But the channel configuration is not limited to this configuration and, for example, a part of the control CH may be allocated to the BCMCS-CH.

Next, a radio communication terminal 1 of the present embodiment will be explained hereunder.

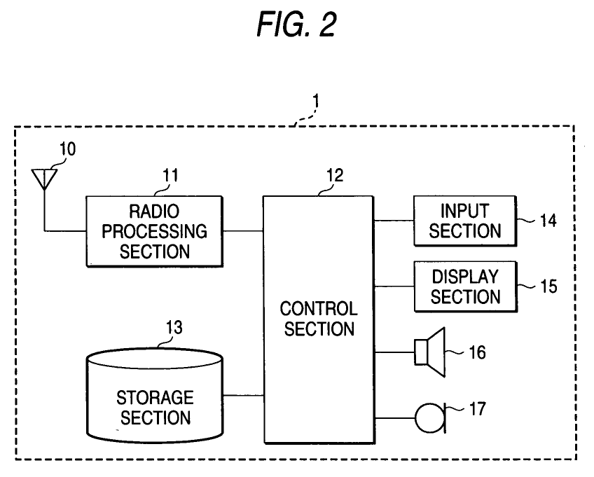

FIG. 2 is a block diagram showing a configuration of the radio communication terminal 1 of the present embodiment.

The radio communication terminal 1 handles the BCMCS reception as well as the normal speech communication and the data communication.

An antenna 10 is connected to a radio processing section 11, and receives a radio wave transmitted from the base station and also transmits the radio wave to the base station.

The radio processing section 11 demodulates a high-frequency signal received via the antenna 10 into a digital signal, and also modulates the digital signal into the high-frequency signal to send the high-frequency signal via the antenna 10.

A control section 12 executes programs stored in a storage section 13 to control the data communicating function and process various services using the radio communication. For example, the control section 12 controls to receive the BCMCS service information and controls to switch the base station to which the radio communication terminal is connected (handoff).

As the handoff, there are a handoff in a communicating state and a handoff in an idle state (idle handoff). In the idle state, the radio communication terminal 1 receives the radio wave from the neighboring base stations based on the information from the neighboring base stations, which are informed from the base station via the control channel, to check the signal quality all the time. As a result, when the base station whose signal quality is better than that of the base station to which the radio communication terminal is communicated currently is found among the neighboring base stations, the radio communication terminal performs a handoff by switching the connection to the new neighboring base station.

The storage section 13 stores the information necessary for the operation of the radio communication terminal 1 and control programs. For example, the service information that the radio communication terminal 1 is now receiving, and the information of the neighboring base stations received from the base station 7 are stored.

Also, an input section 14 serving as an interface to the user, a display section 15, an earpiece section 16, and a mouthpiece section 17 are provided to the radio communication terminal 1.

The input section 14 accepts inputs of characters and numerals and the operational instruction to the radio communication terminal 1. The display section 15 is controlled by the control section 12, and is composed of a liquid crystal display panel for displaying character information, image information, operating conditions (field strength, remaining battery life, time, etc.) of the radio communication terminal 1, and the like, and a backlight for illuminating the liquid crystal display panel.

The earpiece section 16 converts the sound signal demodulated by the radio processing section 11 and outputs an acoustic signal.

The mouthpiece section 17 converts the input acoustic signal into an electric signal.

In the present embodiment, the radio processing section 11 functions as a communication section, and the control section 12 functions as a control section.

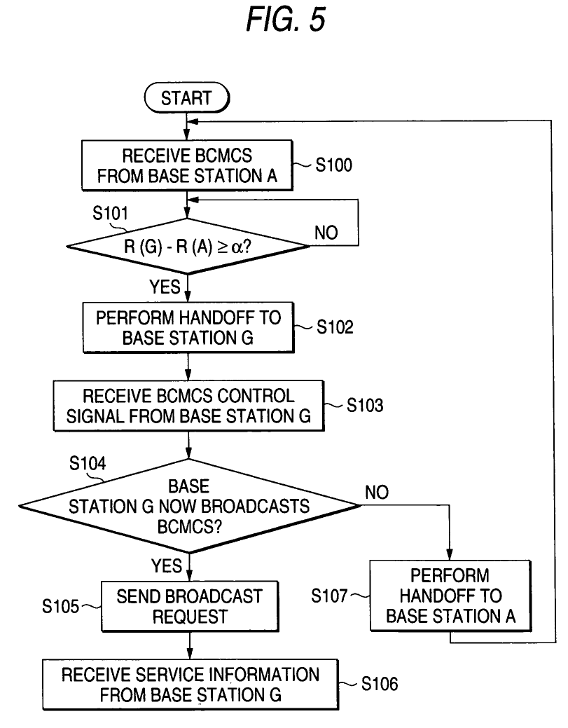

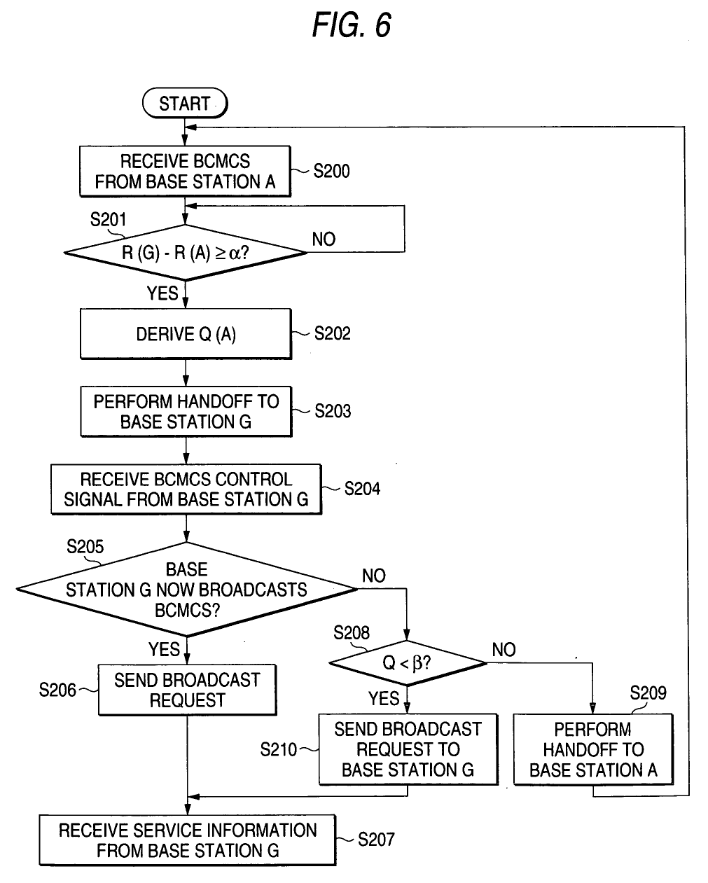

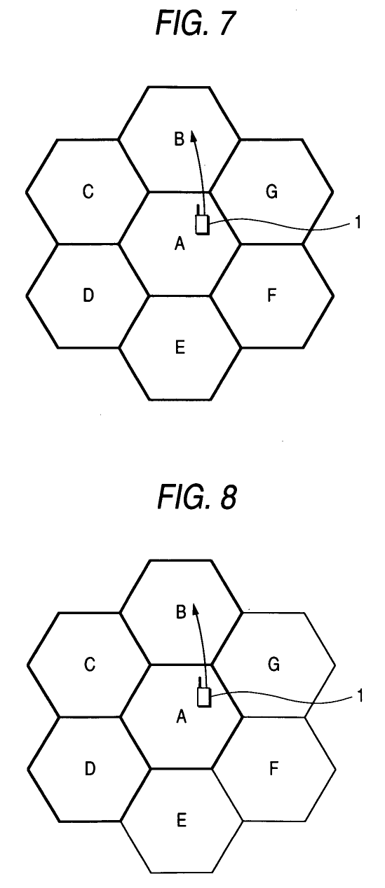

Next, a handoff process of the radio communication terminal 1 of the above embodiment of the invention will be explained with reference to FIG. 5 to FIG. 8 hereunder.

### First Embodiment

Assumed that the base stations A to D now broadcast the BCMCS service information but the base stations E to G do not broadcast the BCMCS service information. At this time, as shown in FIG. 8, the radio communication terminal 1 is located within the cell that the base station A covers, and receives the service information broadcasted from the base station A. The user moves toward the base station B (in the direction indicated with an arrow) while holding the radio communication terminal 1 in his or her hand (S100). In this case, the radio communication terminal 1 goes across a cell edge of the base station G located adjacent to the base stations A and B before the radio communication terminal 1 arrives at the base station B. At this time, a field strength R(A) from the base station A decreases, while a field strength R(G) from the base station G increases. Thus, the radio communication terminal 1 compares R(A) with R(G) to decide whether or not the handoff should be made (S101). In S101, if a difference between R(G) and R(A) is equal to or greater than a predetermined threshold value α, the control section 12 controls the radio communication terminal 1 to perform a handoff from the base station A to a base station G (S102). After the handoff is performed, the radio processing section 11 of the radio communication terminal 1 receives the BCMCS control signal transmitted over the BCMCS broadcast channel from the base station G via the antenna 10 (S103). The control section 12 of the radio communication terminal 1 decides based on the BCMCS control signal whether or not the base station G now broadcasts the BCMCS service information (S104) If the base station G now broadcasts the service information, the radio communication terminal 1 sends the broadcast request of the service information to the base station G (S105), and also starts the reception of the service information broadcasted by the base station G (S106).

In contrast, in step S104, if the base station G does not broadcast the service information at present, the control section 12 controls the radio communication terminal 1 not to send the broadcast request of the service information to the base station G, and controls to immediately performs a handoff from the base station G to the base station A (S107). Then, the radio communication terminal 1 establishes the connection with the base station A again, and receives the service information from the base station A.

As explained above, in the first embodiment, the radio communication terminal 1 performs a handoff once based on the field strength from the base station. However, when the base station as the destination of handoff does not broadcast the service information, the radio communication terminal 1 sends back the connection immediately to the base station as the source of handoff.

According to the first embodiment, even if just one radio communication terminal enters into the service area at a moment, the base station as the destination of handoff does not immediately start the broadcast of the service information in which a part of the traffic channels is allocated to the BCMCS channel. As a result, the radio resource is prevented from being used wastefully.

### Second Embodiment

A handoff control realized by improving further the above control in the first embodiment is executed in a second embodiment. In the second embodiment, not only the wasteful use of the radio resource can be prevented but also QoS (Quality of Service) indicating that the receiving service information is not disconnected can be improved.

Assumed that the base stations A to D now broadcast the BCMCS service information but the base stations E to G do not broadcast the BCMCS service information. At this time, as shown in FIG. 8, the radio communication terminal 1 is located within the cell that the base station A covers, and receives the service information broadcasted from the base station A. The user moves toward the base station B (in the direction indicated with an arrow) while holding the radio communication terminal 1 in his or her hand (S200). In this case, the radio communication terminal 1 goes across the cell edge of the base station G located adjacent to the base stations A and B before the radio communication terminal 1 arrives at the base station B. At this time, a field strength R(A) from the base station A decreases, while a field strength R(G) from the base station G increases. Thus, the radio communication terminal 1 compares R(A) with R(G) to decide whether or not the handoff should be made (S201). In S201, if a difference between R(G) and R(A) is equal to or greater than a predetermined threshold value α, the control section 12 of the radio communication terminal 1 derives a signal quality Q(A) of the service information that is received currently (S202). The signal quality Q(A) is, for example, a bit error rate of the service information data may be calculated based on CRC (cyclic redundancy check). After the signal quality Q(A) is derived, the control section 12 controls the radio communication terminal 1 to perform a handoff from the base station A to the base station G (S203). After the handoff is completed, the radio processing section 11 of the radio communication terminal 1 receives the BCMCS control signal transmitted over the BCMCS broadcast channel from the base station G via the antenna 10 (S204). The control section 12 of the radio communication terminal 1 decides based on the BCMCS control signal whether or not the base station G now broadcasts the BCMCS service information (S205). If the base station G now broadcasts the service information, the radio communication terminal 1 sends the broadcast request of the service information to the base station G (S206), and also starts the reception of the service information broadcasted by the base station G (S207).

In contrast, in step S205, if the base station G does not broadcast the service information at present, the control section 12 of the radio communication terminal 1 decides whether or not Q(A) acquired in step S202 satisfies predetermined signal quality β, that is, Q(A) is smaller than a predetermined threshold value β (S208) If Q(A) satisfies β, the control section 12 controls the radio communication terminal 1 not to send the broadcast request of the service information to the base station G, and also controls to immediately perform a handoff from the base station G to the base station A (S209). Then, the radio communication terminal 1 establishes the connection with the base station A again, and receives the service information from the base station A.

On the other hand, if Q(A) does not satisfy β, the control section 12 controls the radio communication terminal 1 to send the broadcast request of the service information to the base station G (S210). Then, the radio communication terminal 1 starts the reception of the service information from the base station G (S207).

As explained above, in the second embodiment, the radio communication terminal 1 performs a handoff once based on the field strength from the base station. However, when the base station as the destination of handoff does not broadcast the service information, and the radio communication terminal 1 can receive the service information from the base station as the source of handoff in good signal quality, the radio communication terminal 1 sends back the connection to the base station as the source of handoff. On the contrary, when the base station as the destination of handoff does not broadcast the service information, and the radio communication terminal 1 cannot receive the service information from the base station as the source of handoff in satisfactory signal quality, the radio communication terminal 1 sends the broadcast request to the base station as the destination of handoff to start the reception of the broadcast of the service information from the base station as the destination of handoff.

According to the second embodiment, even if just one radio communication terminal enters into the service area at a moment, the base station as the destination of handoff does not immediately start the broadcast of the service information in which a part of the traffic channels is allocated to the BCMCS channel. As a result, the radio resource is prevented from being used wastefully. Further, when the radio communication terminal 1 cannot receive the service information from the base station as the source of handoff in satisfactory signal quality, the radio communication terminal 1 causes the base station as the destination of handoff to start the broadcast and receives the service information. Therefore, the reception of service information is never disconnected on the radio communication terminal side. As a result, QoS (Quality of Service) can be improved.

As explained above, according to the first and second embodiments of the present invention, when the radio communication terminal performs a handoff to the other base station while the radio communication terminal 1 receives the BCMCS service information, it can be prevented the radio resource from being used wastefully without a reduction of the signal quality of the service information.

In the above embodiments, an example in which the signal quality of the service information is decided based on CRC (cyclic redundancy check) is explained. But the present invention is not limited to this example. It is needless to say that, for example, the signal quality of the service information may be decided based on various error correcting codes such as a parity check (even-odd check), a check sum, or the like.

What is claimed is:

1. A radio communication terminal, comprising:
a communication section which communicates with a base station; and
a control section which controls a handoff between a plurality of base stations,
wherein the communication section receives a control information indicating whether or not a neighboring base station broadcasts a service information from the neighboring base station when the radio communication terminal performs a handoff from a first base station to the neighboring base station while the radio communication terminal receives the service information broadcasted from the first base station, and
the control section controls to perform a handoff from the neighboring base station to the first base station when the control section decides that the neighboring base station does not broadcast the service information based on the control information, after the radio communication terminal performs the handoff from the first base station to the neighboring base station.

2. The radio communication terminal according to claim 1,
a control section derives signal quality of the service information while the radio communication terminal receives the service information broadcasted from the first base station, and
the control section controls to perform the handoff from the neighboring base station to the first base station when the control section decides that the neighboring base station does not broadcast the service information based on the control information and the signal quality is greater than or equal to a predetermined value, after the radio communication terminal performs the handoff from the first base station to the neighboring base station.

3. The radio communication terminal according to claim 1,
a control section derives signal quality of the service information while the radio communication terminal receives the service information broadcasted from the first base station, and
the control section controls to continue a communication with the neighboring base station and controls the communication section to send a broadcast request of the service information to the neighboring base station when the control section decides that the neighboring base station does not broadcast the service information based on the control information and the signal quality is smaller than a predetermined value, after the radio communication terminal performs the handoff from the first base station to the neighboring base station.

4. The radio communication terminal according to claim 2,
wherein the signal quality is a bit error rate while the communication section receives the service information.

5. The radio communication terminal according to claim 3,
wherein the signal quality is a bit error rate while the communication section receives the service information.

6. The radio communication terminal according to claim 1,
wherein the control section controls to perform the handoff from the first base station to the neighboring base station when a difference between a field strength from the neighboring base station and a field strength from the first base station exceed a threshold value.

7. A handoff control method of a radio communication terminal comprising a communication section which communicates with a base station, and a control section which controls a handoff between a plurality of base stations, comprising the steps of:
controlling to perform a handoff from a first base station to a neighboring base station while the radio communication terminal receives a service information broadcasted from the first base station,
receiving a control information indicating whether or not the neighboring base station broadcasts a service information from the neighboring base station, after the radio communication terminal performs a handoff from the first base station to the neighboring base station,
deciding whether or not the neighboring base station broadcasts the service information based on the control information, and
controlling to perform a handoff from the neighboring base station to the first base station when the control section decides that the neighboring base station does not broadcast the service information.

8. The handoff control method according to claim 7, further comprising the steps of:
deriving signal quality of the service information while the radio communication terminal receives the service information broadcasted from the first base station,
wherein the control section controls to perform the handoff from the neighboring base station to the first base station when the control section decides that the neighboring base station does not broadcast the service information based on the control information and the signal quality is greater than or equal to a predetermined value, after the radio communication terminal performs the handoff from the first base station to the neighboring base station.

9. The handoff control method according to claim 7, further comprising the steps of:
deriving signal quality of the service information while the radio communication terminal receives the service information broadcasted from the first base station,
wherein the control section controls to continue a communication with the neighboring base station and controls the communication section to send a broadcast request of the service information to the neighboring base station when the control section decides that the neighboring base station does not broadcast the service information based on the control information and the signal quality is smaller than a predetermined value, after the radio communication terminal performs the handoff from the first base station to the neighboring base station.

10. The handoff control method according to claim 8,
wherein the signal quality is a bit error rate while the communication section receives the service information.

11. The handoff control method according to claim 9,
wherein the signal quality is a bit error rate while the communication section receives the service information.

12. The handoff control method according to claim 7,
wherein the control section controls to perform the handoff from the first base station to the neighboring base station when a difference between a field strength from the neighboring base station and a field strength from the first base station exceed a threshold value.
